(19) United States
(12) Patent Application Publication
(10) Pub. No.: US 2009/0088874 A1
(43) Pub. Date: Apr. 2, 2009

(54) Valve manifold assemblies and method of operating valve manifold assemblies

(76) Inventors: Emmanuel Arceo, Bloomfield, NJ (US); Enrico De Carolis, Oakland Township, MI (US); John F. Eskew, Phoenix, AZ (US)

Correspondence Address: REISING, ETHINGTON, BARNES, KISSELLE, P.C., P O BOX 4390, TROY, MI, 48099-4390, US

(21) Appl. No.: 11/906,459

(22) Filed: Oct. 2, 2007

(51) Int. Cl. G05B 19/048

(52) U.S. Cl. 700/79

(57) ABSTRACT

A fieldbus valve station with a valve manifold and a communications module having a bus communication unit mounted therein for using a fieldbus protocol and connectable to a fieldbus network and to provide local and peer to peer network control by the valve station if a fault is detected or there is a break from the main fieldbus network.

### TECHNICAL FIELD

The field of this invention relates to pneumatic valve manifold assemblies and a method of operating pneumatic valve manifold assemblies.

### BACKGROUND OF THE DISCLOSURE

Industrial and process control automation uses many control devices. One useful control device combines a plurality of electrically actuated solenoids that control through valves the direction of hydraulic or pneumatic flow for actuating other downstream devices. These valves are often housed in modular assemblies and positioned to abut each other to form a valve manifold This valve manifold has also been connected to a communication module which may have a control board mounted therein capable of being connected to an industrial communication network often referred to as a fieldbus. The communication module is also often connected to modular I/O units. The assembly of a main communication module, valve manifold and I/O units are often referred to as a valve station.

Fieldbus networks have seen a certain degree of success in automation control. The fieldbus network provides centralized control over the valve stations. Typical fieldbus networks that centralize control may be Ethernet/IP, FIPIO, Interbus-S, ControlNet, or DeviceNet. The valve station is connected to a fieldbus network usually mastered by a remote programmable logic controller (PLC), industrial personal computer (IPC), or distributed control system (DCS).

The schedule and operation for opening and closing of the valves in the valve station are thus controlled via the fieldbus network with no independence at the valve station. Thus, for example if the field bus network connected to the PLC becomes physically cut or detached from the valve station and other parts of the fieldbus, the detached part of the fieldbus network may become inoperable. The valve stations have no ability to communicate with other valve stations and other devices, in other words, valve stations have no peer to peer communication ability. Thus, if the main fieldbus connection with the PLC becomes detached or becomes inoperable, the valve station also ceases to function.

Other process control networks have used a fieldbus protocol by the name of Foundation Fieldbus. The Foundation Fieldbus provides for decentralized control systems that have been used in controlling individual processes in devices.

What is needed is a valve station that has the ability to operate independently on a preprogrammed logic in its control module and to provide peer to peer communication over the fieldbus to other similar valve stations or other fieldbus devices. What is further desired is a valve station that uses Foundation Fieldbus protocol. What is needed is a method to operate a valve station with either central control or distributed control.

### SUMMARY OF THE DISCLOSURE

In accordance with one aspect of the invention, a modular valve manifold system has a valve station with at least one operable valve therein, and a main communication module for controlling the valve station. The main communication module has a bus communication unit mounted therein. The main communication module has an input for communication to a fieldbus network operated with a programmable logic controller or distributed control system. The bus communication unit is constructed with a microprocessor programmed with a system schedule wherein the microprocessor is able to execute the system schedule and to provide local decisional output signals from the bus communication unit if the microprocessor detects that the PLC or DCS has a fault or is disconnected.

Preferably, the valve station has at least one modular I/O unit and the bus communication unit is constructed for obtaining parameter signals from the modular I/O unit. The bus communication unit provides an appropriate output signal for diagnosing if the parameter signals are within a predetermined acceptable range.

In accordance with another aspect of the invention, a fieldbus system has a valve station with at least one operable valve therein, a main communication module for controlling the valve station, and at least one modular I/O unit connected to the main communication module. The main communication module has a bus communication unit mounted therein. The main communication module has an input for communication to a fieldbus network operated with a PLC or DCS. The bus communication unit is constructed with a microprocessor which is programmed with a system schedule using Foundation Fieldbus protocol wherein the microprocessor operates from Foundation Fieldbus protocol from the fieldbus network and is able to detect lack of a signal from the fieldbus network and to execute the system schedule to provide local decisional output signals from the bus communication unit when the lack of a signal is detected from the fieldbus network with the programmed logic computer to control the at least one operable valve. The bus communication unit is also constructed for obtaining parameter signals from the I/O unit which provides an appropriate output signal to the fieldbus network for diagnosing if the parameter signals are within a predetermined acceptable range. It is also preferred that the valve station can provide peer to peer communication from the bus communication unit when the lack of signal is detected. Peer to peer communication can be used to either control the devices on the network from the valve station or using input from the other devices as a parameter to control the valves in the valve station.

In accordance with another aspect of the inventions, a fieldbus system has a valve station with at least one operable valve therein and a main communication module for controlling the valve station. The main communication module has a bus communication unit mounted therein. The main communication module has an input for communication to a fieldbus network operated with a programmable logic controller. The bus communication unit is constructed with a microprocessor which is programmed with a system schedule using Foundation Fieldbus protocol wherein the microprocessor operates from Foundation Fieldbus protocol from the fieldbus network, and is able to detect lack of a signal from the network and to execute the system schedule and to provide local decisional output signals from the bus communication unit when the lack of a signal is detected from the fieldbus network with the programmed logic computer to control the at least one operable valve.

In accordance with another aspect of the invention, a method of operating a fieldbus valve manifold assembly with a plurality of valve units includes the steps of; providing primary control in a primary mode through signals from a fieldbus network to a main communication module of the fieldbus valve manifold assembly for operating the plurality of valve units, detecting lack of a signal from the fieldbus network for a predetermined period of time through the main communication module, and providing local control to operate the valves in a secondary mode through a program in the main communication module upon the detection of lack of a signal for a predetermined time.

### BRIEF DESCRIPTION OF THE DRAWINGS

Reference now is made to the accompanying drawings in which:

FIG. 1 is a schematic view of a fieldbus network incorporating a valve station using a fieldbus according to one embodiment of the invention;

FIG. 2 is an enlarged schematic view of the valve station shown in FIG. 1 connected to operating valves and other devices; and

FIG. 3 is an enlarged and partially sectioned view of a main communication module with a bus communication unit therein.

### DETAILED DESCRIPTION OF THE PREFERRED EMBODIMENT

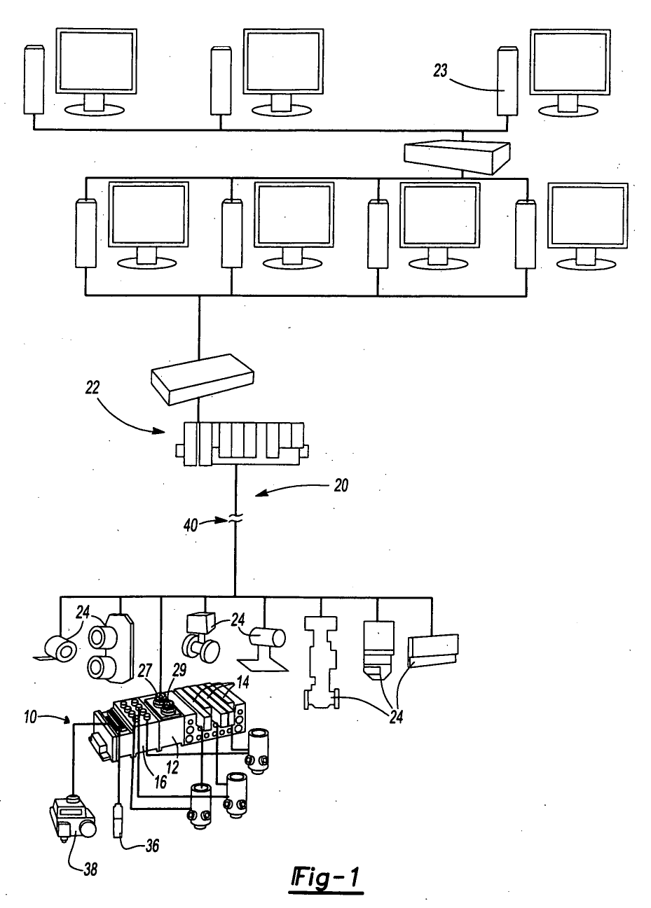

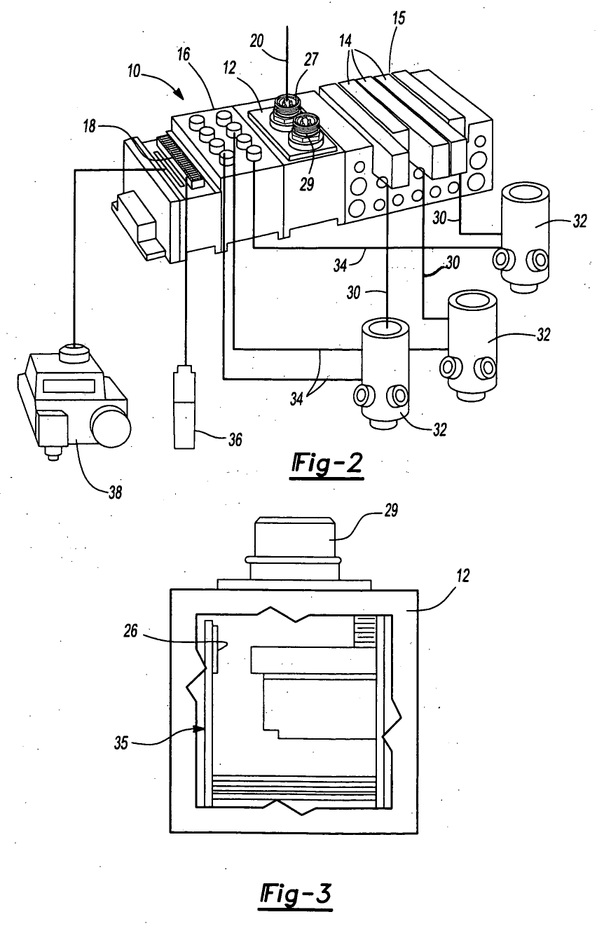

Referring now to FIGS. 1 and 2, one arrangement of a modular valve fieldbus valve station 10 includes a main communication module 12 operably connected to a series of modular solenoid actuated valve units 14 at one side thereof that, as stacked together, are often referred to as a valve manifold 15. Optional I/O modules 16 and 18 are connected to the other side of the main communication module. Suitable hardware components for such valve units 14, I/O modules 16 and 18 and the case for the main communication module 12 for such a fieldbus system are available from Numatics Incorporated of Highland, Mich., USA under its G2-2 fieldbus communications electronics.

The field bus valve station 10 is connectable to a fieldbus network 20 as shown in FIG. 1 that may include other components such as a remote central programmable logic controller (PLC) 22 that also may be connect to an Ethernet network system 23 and a plurality of other fieldbus devices 24 and additional modular valve fieldbus system 10.

As shown in FIG. 3, the main communication module 12 has a bus communication unit 25 therein with a microprocessor 26 having memory and local logic capability. The microprocessor 26 is produced to be suitable to use and incorporate Foundation™ Fieldbus. One such microprocessor that is suitable for such use is available in the 848L Logic Transmitter from Rosemount. Foundation Fieldbus is an open, nonproprietary fieldbus architecture that provides a communication protocol for control and instrumentation systems in which each control device 24 shown in FIG. 1 has its own intelligence and communicates via an all-digital, serial, two-way communications system. Furthermore, the Foundation Fieldbus incorporates a link active scheduler service that provides the ability of a branch or slave valve station to act as a master if the main controller or main network segment fails. The bus communication unit 25 is operably connected to the communication fitting 27 as shown in FIG. 2 and the auxiliary power fitting 29 on the top of main communication module 12.

The solenoid actuated valve units 14 as most clearly shown in FIG. 2 may have output pneumatic lines 30 operably connected to valve actuator devices 32. Furthermore electrical lines or wires 34 may extend from the valve actuator devices 32 back to the I/O modules 16.

Other devices 36 and 38 may be attached to the I/O module 18. For example device 36 may be a sensor and device 38 may be a drive unit. The devices 36 and 38 may be operated using the fieldbus in the valve station from control module 12. The devices 36 and 38 no longer need their own fieldbus interface as when they were otherwise plugged or connected directly into fieldbus 20 thereby decreasing their unit cost and the overall complexity of the network architecture.

The advantages of such a system using Foundation Fieldbus in the valve station 10 are several fold. Firstly, the valve station 10 with its plurality of valves 14 is provided with its own intelligence and has the link active scheduler service via the Foundation Fieldbus. In other words, the bus control unit with its memory is provided with a programmed schedule. If perchance the PLC 22 goes down or the PLC 22 becomes disconnected from the valve station 10 such as by a catastrophic break in the network, for example at location 40, the bus control unit senses the lack of control by the PLC 22. If no signal is received from the PLC for a predetermined amount of time, the bus control unit 25 becomes the master and will take over control of the operation of the valve units 14 to provide a second mode of operation.

Furthermore, the main communications module 12 is connected to the portion of the fieldbus system 20 that still may be in communication with other devices 24 and may have peer to peer communications. Depending on the program and sensed inputs, the program provides a fail safe condition i.e. the second mode of operation when a fault condition is sensed, e.g. communication is lost from the PLC. Depending on the application, the fail safe condition may continue to operate valves 10, may also take over control of devices 24, may cease any new programs from starting and continuing only necessary and vital presently running programs, may hold the last state, or may provide emergency shut down if appropriate.

This link active scheduler service in a valve station 10 provides the valve station with greater adaptability and assurance that the actuated valves and other network participants open and close as needed even during partial shutdown or misoperation of the fieldbus network 20.

Furthermore, the Foundation Fieldbus provides feedback from the valves 32 through lines 34 leading back to the I/O modules 16 which may send signals back to the communications module 12 where it is diagnosed. If subpar performance or a fault is detected, the PLC may provide an appropriate alarm, signal or instructions to an operator.

The valve station 10 may as part of the fail safe mode, drag or import information from the other devices 24 and other parts of the fieldbus network 20 with which it is still in communication in order to provide the appropriate fail safe mode.

Variations and modifications are possible without departing from the scope and spirit of the present invention as defined by the appended claims.

The embodiments in which an exclusive property or privilege is claimed are defined as follows:

1. A modular valve manifold system comprising:
a valve station having at least one operable valve therein, and a main communication module for controlling the valve station;
said main communication module having a bus communication unit mounted therein;
said main communication module having an input for communication to a fieldbus network operated with a programmable logic controller or distributed control system; and
said bus communication unit being constructed with a microprocessor which is programmed with a system schedule wherein the microprocessor is able to execute the system schedule and to provide local decisional output signals from the bus communication unit if the microprocessor detects that said programmed logic controller has a fault or is disconnected.

2. A modular valve manifold system as defined in claim 1 further comprising:
said bus communication unit constructed to read inputs from a local network and to provide output to said local network for peer to peer network control.

3. A modular valve manifold system as defined in claim 2 further comprising:
said valve station having at least one modular I/O unit; and
said bus communication unit being constructed for obtaining parameter signals from said modular I/O unit and to provide an appropriate output signal for diagnosing if said parameter signals are within a predetermined acceptable range.

4. A modular valve manifold system as defined in claim 1 further comprising:
said valve station having at least one modular I/O unit; and
said bus communication unit being constructed for obtaining parameter signals from said modular I/O unit and to provide an appropriate output signal for diagnosing if said parameter signals are within a predetermined acceptable range.

5. A fieldbus system comprising:
a valve station having at least one operable valve therein, a main communication module for controlling the valve station, and at least one modular I/O unit connected to the main communication module;
said main communication module having a bus communication unit mounted therein;
said main communication module having an input for communication to a fieldbus network operated with a programmable controller;
said bus communication unit being constructed with a microprocessor which is programmed with a system schedule using Foundation Fieldbus protocol wherein the microprocessor operates from Foundation Fieldbus protocol from said fieldbus network and is able to detect lack of a signal from said fieldbus network and to execute the system schedule and to provide local decisional output signals from the bus communication unit when the lack of a signal is detected from said fieldbus network with the programmed logic computer to control said at least one operable valve; and
said bus communication unit being constructed for obtaining parameter signals from said I/O unit which then provides an appropriate output signal to said fieldbus network for diagnosing if said parameter signals are within a predetermined acceptable range.

6. A fieldbus system as defined in claim 5 further comprising:
said bus communication unit being constructed to provide peer to peer network control when said lack of signal is detected.

7. A fieldbus system comprising:
a valve station having at least one operable valve therein and a main communication module for controlling the valve station;
said main communication module having a bus communication unit mounted therein;
said main communication module having an input for communication to a fieldbus network operated with a programmable logic controller; and
said bus communication unit being constructed with a microprocessor which is programmed with a system schedule using Foundation Fieldbus protocol wherein the microprocessor operates from Foundation Fieldbus protocol from said fieldbus network, and is able to detect lack of a signal from said network and to execute the system schedule and to provide local decisional output signals from the bus communication unit when the lack of a signal is detected from said fieldbus network with the programmed logic computer to control said at least one operable valve.

8. A fieldbus system as defined in claim 7 further comprising:
said bus communication unit being constructed to provide peer to peer network control when said lack of signal is detected.

9. A fieldbus system as defined in claim 7 further comprising:
a local device operating under Foundation Fieldbus protocol; and
said valve station providing said local decisional output signals to said fieldbus network to operate said local device in the absence of other signals from said fieldbus network.

10. A fieldbus system as defined in claim 9 further comprising:
said bus communication unit being constructed to provide peer to peer network control when said lack of signal is detected.

11. A method of operating a fieldbus valve manifold assembly with a plurality of valve units including the steps of:
providing primary control in a primary mode through signals from a fieldbus network to a main communication module of said fieldbu's valve manifold assembly for operating said plurality of valve units;
detecting lack of a signal from said fieldbus network for a predetermined period of time through said main communication module; and
providing local control to operate said valves in a secondary mode through a program in said main communication module upon the detection of lack of signals.

12. A method as defined in claim 11 further comprising:
providing peer to peer network control to said fieldbus network upon said detection of lack of signals.
